(19) United States
(12) Patent Application Publication
(10) Pub. No.: US 2001/0034601 A1
(43) Pub. Date: Oct. 25, 2001

(54) Voice activity detection apparatus, and voice activity/non-activity detection method

(76) Inventors: Kaoru Chujo, Sunnyvale, CA (US); Toshiaki Nobumoto, Fukuoka (JP); Mitsuru Tsuboi, Kawasaki (JP); Naoji Fujino, Kawasaki (JP); Noboru Kobayashi, Kawasaki (JP)

Correspondence Address: Helfgott & Karas, P.C., 350 Fifth Avenue, Suite 6024, New York, NY, 10118, US

(21) Appl. No.: 09/860,144

(22) Filed: May 17, 2001

Related U.S. Application Data
(63) Continuation of application No. PCT/JP99/00487, filed on Feb. 5, 1999.

(51) Int. Cl. G10L 15/20

(52) U.S. Cl. 704/233

(57) ABSTRACT

On the basis of parameters representing background noise characteristics and parameters representing voice characteristics of a current frame, a voice activity detector 42 identifies whether the current frame is a non-active voice segment of background noise only or an active voice segment in which background noise has been superimposed on voice. The voice activity detector updates the background-noise characteristic parameters in each frame, irrespective of whether requirements for updating the background-noise characteristic parameters have been satisfied, in an interval of time from start of a steady operation for detection of voice activity to identification of an active voice segment. Further, the voice activity detector 42 relaxes the update requirements of the background-noise characteristic parameters based upon results of voice activity and voice non-activity detection and, when these requirements have been satisfied, updates the background-noise characteristic parameters. As a result, processing for updating the background-noise characteristics parameters will not stop, thereby allowing these parameters to reflect the latest background noise at all times. This makes it possible to identify an active voice segment and a non-active segment easily and precisely.

### TECHNICAL FIELD

This invention relates to a voice activity detection apparatus and voice activity/non-activity detection method in a voice encoder. More particularly, the invention relates to a voice encoder which transmits information for generating background noise only when necessary in non-active voice segments, and to a voice activity detection apparatus and voice activity/non-activity detection method in this voice encoder.

### BACKGROUND ART

In human conversation there exist intervals with speech (active voice segments) and intervals without speech (non-active voice segments) during which conversation pauses or in which one waits silently for the other party to speak. In general, background noise produced in an office, by vehicles or from the street is superimposed upon speech. In actual voice communication, therefore, there are intervals (active voice segments) in which background noise is superimposed upon speech, and intervals (non-active voice segments) consisting solely of background noise. This means that a large-scale reduction in amount of transmission can be achieved by detecting non-active voice segments and halting the transmission of information in the non-active voice segments. However, with a method that does not transmit background-noise information in non-active voice segments, either no output is produced on the receiving side or the receiving side must output a certain level of noise in the non-active voice segments when speech is reconstructed on the receiving side. This produces an unnatural condition that seems odd to the listener. In other words, background noise is necessary to impart naturalness in terms of the sense of hearing.

Accordingly, non-active voice compression technology has been developed. Utilizing the fact that a change in background noise is comparatively small, this technology transmits information necessary to generate background noise only when a large change in background noise has occurred and halts the transmission of information in non-active voice segments if there is no large change in background noise, thereby making possible natural, normal reconstruction of speech on the receiving side while reducing the amount of transmission of background noise.

Such non-active voice compression technology is extremely important in the efficient multiplexed transmission of voice and data in multimedia communications. Of particular importance is voice non-activity/voice activity detection technology for detecting voice non-activity/voice activity segments with high precision, and technology for transmitting information necessary to generate artificial background noise with high precision and generating background noise based upon this information.

FIG. 7 is a diagram showing the configuration of a communication system which implements a non-active voice compression communication scheme. A encoder side (transmitting side) 1 and a decoder side (receiving side) 2 are connected via a transmission line 3 so as to be capable of sending and receiving information in accordance with a predetermined communication scheme.

The encoder side 1 is provided with a voice activity detector 1a, an active voice segment encoder 1b, a non-active voice segment encoder 1c and changeover switches 1d, 1e. A digital voice signal is input to the voice activity detector 1a, which identifies the active voice segments and non-active voice segments of the input signal. If a segment is an active voice segment, the active voice segment encoder 1b encodes the input signal in accordance with a predetermined encoding scheme. If a segment is a non-active voice segment, the non-active voice segment encoder 1c (1) encodes and transmits background-noise information only when it is necessary to transmit information in order to generate background noise, and (2) halts the transmission of information when the transmission of information for generating background noise is unnecessary. The voice activity detector 1a transmits voice activity/non-activity-identification information from the encoder side 1 to the decoder side 2 at all times. In actuality, however, there are many cases where it is so arranged that information in non-active voice segments need not be transmitted.

The decoder side 2 is provided with an active voice segment decoder 2a, a non-active voice segment decoder 2b and changeover switches 2d, 2e. If, on the basis of the voice activity/non-activity-identification information sent from the encoder 1, a segment is an active voice segment, the active voice segment decoder 2a decodes the encoded data to the original voice data in accordance with a predetermined decoding scheme and outputs the decoded data. If, on the basis of the voice activity/non-activity-identification information, a segment is a non-active voice segment, the non-active voice segment decoder 2b generates and outputs background noise based upon the background-noise information sent from the encoder side.

FIG. 8 is an abbreviated flowchart of voice activity/non-activity identification performed by the voice activity detector 1a. The voice activity detector identifies whether the input signal is voice activity or voice non-activity by comparing parameters representing a feature of the input signal and parameters representing a feature of a segment solely of background noise. In order to perform precise discrimination, it is necessary that the parameters representing the feature of the segment solely of background noise be updated successively in accordance with an actual change in the characteristics of the background noise.

The initial step of the processing, therefore, is for the voice activity detector 1a to extract parameters necessary for voice activity/non-activity identification from the input signal (parameter extraction; step 101).

Next, the voice activity detector makes the voice activity/non-activity identification using the extracted parameters and the internally retained parameters representing the feature of the segment solely of background noise (referred to as “background-noise characteristic parameters” below) (step 102).

Finally, the background-noise characteristic fluctuates and the voice activity detector judges whether it is necessary to re-calculate the background-noise characteristic parameters (determination as to whether the background-noise characteristic parameters should be updated; step 103).

If updating is necessary, the voice activity detector calculates the background-noise characteristic parameter afresh (updating of background-noise characteristic parameter; step 104). The foregoing steps are thenceforth repeated.

When voice activity detection is performed using the voice activity detector 1a, the background-noise characteristic parameter is used as the criterion. Consequently, the extent to which it is possible to calculate a background-noise characteristic parameter that conforms to the actual change in background noise has a major influence upon the result of identification. However, there is the likelihood that a state will be attained in which the background-noise characteristic parameter cannot be calculated, as when the system waits until a background-noise characteristic parameter can be calculated stably following resetting of the voice activity detector, or under special conditions where there is no input being applied. As a result, the background-noise characteristic parameter will no longer be appropriate and will not reflect the latest background noise. As a consequence, voice activity and voice non-activity cannot be identified correctly and a segment may be judged as being voice activity even though it is a non-active voice segment solely of background noise. This can lead to a pronounced decline in non-activity detection rate.

A specific example of this phenomenon will be described for a case where the scheme of ITU-T G.729 ANNEX B is used as the non-active voice compression scheme. The configuration of a system for implementing the scheme of ITU-T G.729 ANNEX B is the same as that shown in FIG. 7. Further, the scheme of ITU-T G.729 ANNEX B presumes use of an 8 k CS-ACELP scheme (ITU-T G.729 or ITU-T G.729 ANNEX A) as the voice encoding scheme and is composed of voice activity detection (VAD: Voice Activity Detection), discontinuous transmission (DTX) and artificial background noise generation (CNG: Comfort Noise Generation).

FIG. 9 is a flowchart illustrating voice activity/non-activity identification processing performed by the voice activity detector 1a, which is compliant with G.729 ANNEX B. Processing for identifying voice activity and non-activity will be described in accordance with this flowchart, then specific phenomena and the causes thereof will be discussed.

The voice activity detector 1a (FIG. 7) executes voice activity decision every frame of 10 ms, which is the same as the operating period of the active voice segment encoder 1b. Digital voice data is sampled every 125 μs and therefore one frame contains 80 samples of data. The voice activity detector 1a performs voice activity decision using these 80 samples of data. Further, whenever the voice activity detector 1a is reset, frames are assigned consecutive numbers (frame numbers) sequentially starting with 0 for the first frame.

At an initial stage, the voice activity detector 1a extracts four basic feature parameters from the voice data of an ith frame (where the initial value of i is 0) (step 201). These parameters are (1) frame energy E_{F} of the full band, (2) frame energy E_{L} of the low band, (3) line-spectral frequency (LSF) and (4) zero-crossing rate (ZC).

The full-band energy E_{F} takes on the logarithm of an autocorrelation coefficient R(0) of order 0. This is indicated by the following equation:

E_{F}=10.log₁₀[R(0)/N] (1)

Here N (=240) is the size of an analytical window for analyzing an LPC (Linear Prediction Coefficient) regarding the voice sample.

The low-band energy E_{L} is energy in the low band from 0 to F_{L} Hz and is calculated in accordance with the following equation:

E_{L}=10.log₁₀[h^{T}Rh/N] (2)

where h represents the impulse response of a FIR filter whose cut-off frequency is F_{L} Hz, and R denotes a Toeplitz autocorrelation matrix in which the diagonal elements are the autocorrelation coefficients.

The line spectral frequency (LSF) is a vector whose elements are LSFi (i≦1 to P). It is expressed by the following equation:

LSF={LSF₁, LSF₂, . . . LSF_{P}} (3)

The line spectral frequency (LSF can be found by the method described in section 3.2.3 of ITU-T G.729 (or in section A.3.2.3 of annex A).

The zero-crossing rate is the number of times the voice signal cross the 0 level. The zero-crossing rate ZC, which is normalized every frame, is calculated in accordance with the following equation:

ZC=Σ[sgn[x(i)]−sgn[x(i−1)]|]2M (4)

where M represents the number of samples, i.e., 80; sgn represents a code function that becomes +1 if x is positive and −1 if x is negative; x(i) denotes the data of the ith sample and x(i−1) the data of the (i−1)th sample. Following the extraction of parameters, a long-term minimum energy Emin is found and the content of a minimum-value buffer is updated (step 202). The long-term minimum energy Emin is the minimum value of the full-band energy E_{F} in the immediately preceding N₀-number of frames.

Next, it is determined whether the frame number is less than a set value Ni (=32) (step 203). If the frame number is less than Ni, then long-term averages (running averages) En⁻, LSF⁻ and ZC⁻of the full-band energy E_{F}, line spectral frequency (LSF) of background noise and background-noise zero-crossing rate (ZC), respectively, are obtained and the old values are updated (step 204). The long-term averages are the average values for all frames thus far.

It is then determined whether the background-noise energy (frame energy of LPC analysis) E_{F} is greater than 15 dB. If it is, the voice activity decision is set forcibly to voice activity; otherwise, the voice activity decision is set forcibly to voice non-activity (step 205). The processing from step 201 onward is repeated for the next frame.

If it is found at step 203 that the frame number is equal to or greater than Ni (=32), then it is determined whether the frame number is equal to Ni (=32) (step 206). If it is equal, then the average energies EF⁻, EL⁻, which are features specific to background noise, are initialized (step 207). The initialization of the average energies E_{F}⁻, E_{L}⁻ is carried out by adding set values K, K′ (K>K′) to the long-term average value En⁻, which is the background-noise energy found at step 204. Thereafter, or if it is found at step 206 that the frame number is greater than Ni (=32), a set of difference parameter is calculated (step 208).

The set of difference parameters is generated as amounts of difference between the above-mentioned four parameters (E_{F}, E_{L}, LSF, ZC) of the current frame and the running means (E_{F}⁻, E_{L}⁻, LSF⁻, ZC⁻) of the four parameters representing the background-noise characteristic. The difference parameters include a spectral distortion measure ΔS, a full-band energy difference measure ΔE_{F}, a low-band energy difference measure ΔE_{L} and a zero-crossing difference measure ΔZC. These are calculated as follows:

The spectral distortion measure ΔS is calculated in accordance with the following equation as the sum of the squares of the differences between the {LSFᵢ} vector of the current frame and the running averages {LSFᵢ⁻} of the background-noise characteristic parameter:

ΔS=Σ(LSFᵢ−LSFᵢ⁻)2 (i=1 to p) (5)

The full-band energy difference measure ΔE_{F} is calculated in accordance with the following equation as the difference between the energy E_{F} of the current frame and the running averages E_{F}⁻ of the background-noise energy:

ΔE_{F}=E_{F}⁻−E_{F} (6)

The low-band energy difference measure ΔE_{L} is calculated in accordance with the following equation as the difference between the low-frequency energy E_{L} of the current frame and the running averages E_{L}⁻ of low-frequency energy of the background noise:

ΔE_{L}=E_{L}⁻−E_{L} (7)

The zero-crossing difference measure ΔZC is calculated in accordance with the following equation as the difference between the zero-crossing rate ZC of the current frame and the running averages ZC⁻ of the zero-crossing rate of background noise:

ΔZC=ZC⁻−ZC (8)

Next, it is determined whether the full-band energy E_{F} of the current frame is less than 15 dB (step 209). If it is smaller, it is judged that the segment is a non-active voice segment (step 210). If the full-band energy E_{F} is equal to or greater than 15 dB, processing for rendering a multi-boundary initial VAD decision is executed (step 211). The result of the initial VAD decision is represented by I_{VD}. If a vector having the above-mentioned four difference parameters as its elements is situated within a non-active voice region, I_{VD} is set to 0 (non-active voice); otherwise, I_{VD} is set to “1” (active voice). A 14-boundary decision in four-dimensional space are defined as follows:

(1) if ΔS>a₁·ΔZC+b₁, then I_{VD}=1

(2) if ΔS>a₂·ΔZC+b₂, then I_{VD}=1

(3) if ΔE_{F}<a₃·ΔZC+b₃, then I_{VD}=1

(4) if ΔE_{F}<a₄·ΔZC+b₄, then I_{VD}=1

(5) if ΔE_{F}<b₅, then I_{VD}=1

(6) if ΔE_{F}<a₆·ΔS+b₆, then I_{VD}=1

(7) if ΔS>b₇, then I_{VD}=1

(8) if ΔE_{L}<a₈·ΔZC+b₈, then I_{VD}=1

(9) if ΔE_{L}<a₉·ΔZC+b₉, then I_{VD}=1

(10) if ΔE_{L}<b₁₀, then I_{VD}=1

(11) if ΔE_{L}<a₁₁·ΔS+b₁₁, then I_{VD}=1

(12) if ΔE_{L}>a₁₂·ΔE_{F}+b₁₂, then I_{VD}=1

(13) if ΔE_{L}<a₁₃·ΔE_{F}+b₁₃, then I_{VD}=1

(14) if ΔE_{L}<a₁₄·ΔE_{F}+b₁₄, then I_{VD}=1

If even one of the above-mentioned 14 requirements is not satisfied, then I_{VD}=0 (non-active voice) will hold. It should be noted that ai, bi (i=1 to 13) represent predetermined constants.

Next, smoothing of the initial VAD decision is performed (step 212). That is, The initial VAD decision is smoothed in order to reflect the long-term steady state of the voice signal. For the details of this smoothing processing, see ITU-T G.729 ANNEX B.

When smoothing processing ends, it is determined whether the requirements for updating the background-noise characteristic parameters have been satisfied (step 213). This means that the conditions for updating the background-noise characteristic parameters are to satisfy all of Equations (9) to (11) below.

The first condition satisfies the following relation:

E_{F}<E_{F}⁻+EFTH (9)

where E_{F} represents the full-band energy E_{F} of the current frame, E_{F}⁻the full-band energy of background noise, and EFTH a set value (EFTH=614 holds according to ITU-T G.729 Annex B). In order to update the background-noise characteristic parameters, it is required that the difference between the full-band energy E_{F} of the current frame and the latest background-noise energy E_{F}⁻ thus far be smaller than the set value EFTH.

The second condition satisfies the following relation:

rc<RCTH (10)

where a reflection coefficient rc is a value representing the characteristics of the human vocal tract and is produced within the encoder, and RCTH represent a set value (RCTH=24576 holds according to ITU-T G.729 Annex B). More specifically, the reflection coefficient rc is a value calculated and used in the process of finding LP filter coefficients from the autocorrelation coefficients of input voice in accordance with the Levinson-Durbin algorithm in the linear prediction analysis performed by the encoder (which corresponds to an analysis of the characteristics of the human vocal tract). For the details, see the C-code comments section of ITU-T G.729. In order to update the background-noise characteristic parameters, it is required that the reflection coefficient rc be smaller than the set value RCTH.

The third condition satisfies the following relation:

SD<SDTH (11)

where SD is information representing the difference between the line spectral frequency LSF of the current frame and the line spectral frequency LSF⁻ of background noise. This is identical with the spectral distortion ΔS obtained from Equation (5). In order to update the background-noise characteristic parameters, it is required that the spectral difference SD be smaller than the set value SDTH (SDTH=83 holds according to ITU-T G.729 Annex B).

The fact that Equations (9) to (11) are satisfied means that the current frame is background noise and, moreover, that a change from background noise stored thus far is large and that it is necessary to update the background-noise characteristic parameters.

FIG. 10 is a flowchart showing the details of processing executed at step 213. It is determined whether all of Equations (9) to (11) have been satisfied (steps 213a to 213c). If any of the requirements of these equations is not satisfied, control returns to step 201 and the above-described processing is repeated with regard to the next frame. If all three of the above-mentioned requirements for updating the background-noise characteristic parameters are satisfied, however, then the background-noise parameters E_{F}⁻, E_{L}⁻, and ZC⁻ are updated (step 214).

The long-term average (running average) of the background-noise characteristic parameters is updated using a first-order auto-regressive scheme. To update each of these parameters, use is made of AR coefficients β_{EF}, β_{EL}, β_{ZC}, β_{LSF} that differ from one another. When a large change in the noise characteristics has been detected, each of the parameters is updated by the auto-regressive scheme using the above-mentioned AR coefficients. The coefficients β_{EF}, β_{EL}, β_{ZC}, β_{LSF} are AR coefficients for updating E_{F}⁻, E_{L}⁻, ZC⁻, LSF⁻, respectively. The total number of frames for which the update requirements are satisfied is counted by Cn and use is made of AR coefficients β_{EF}, β_{EL}, β_{ZC}, β_{LSF} of a set that differs depending upon the value of Cn.

The parameters E_{F}⁻, E_{L}⁻, ZC⁻, LSF⁻ of the background-noise characteristics are updated in accordance with the auto-regressive scheme by means of the following equations:

E_{F}⁻=β_{EF}·E_{F}⁻+(1−β_{EF})·E_{F} (12)

E_{L}⁻=β_{EL}·E_{L}⁻+(1−β_{EL})·E_{L} (13)

ZC⁻=β_{ZC}·ZC⁻+(1−β_{ZC})·ZC (14)

LSF⁻=β_{LSF}⁻+(1−β_{LSF})·LSF (15)

Further, if the frame number is smaller than N₀ (=128) and E_{F}⁻<Emin holds, then the following operation is performed:

E_{F}⁻=Emin, Cn=0

The processing from step 201 onward is then repeated using the updated background-noise characteristic parameters.

Specific phenomena will now be described.

Phenomena which cause a marked decline in the non-active voice detection rate mentioned earlier may occur after the resetting of the voice activity detector 1a or even during ordinary operation, and it is understood that such phenomena tend to occur especially under the conditions of cases 1 and 2 below.

Case 1 is as follows: when voice activity/non-activity identification processing is started after the voice activity detector 1a is reset, first a non-active voice signal or low-level noise signal enters and then is followed by input of a voice signal on which a noise signal having a signal level higher than that of the former signal is superimposed.

Case 2 is as follows: voice signal on which background noise signal has been superimposed enters after a no-input state continues for a time during ordinary operation.

These cases will now be described in detail.

Case 1:

If, following resetting of the voice activity detector 1a, first a non-active voice signal or low-level noise signal enters and then is followed by input of a voice signal on which a noise signal having a signal level higher than that of the former signal is superimposed, the signal will be judged to be voice activity even if it is a non-active voice interval consisting solely of the noise signal. FIG. 11 illustrates an example of this phenomenon, in which (a) indicates the input voice signal and (b) a voice activity/non-activity decision signal. In this example, a non-active voice signal (“ff” in μ-Law PCM) is input for a time (time period T₁ ) following the resetting of the voice activity detector 1a, then only background noise whose average noise level is −50 dBm enters (time period T₂), and then voice signal whose average level is −20 dBm enters according to circumstances in a form superimposed on the background noise (time period T₃). If such a voice signal is input, the voice activity detector 1a judges that the entire interval that follows the time period T₁ of the non-active voice signal is an active voice segment in its entirety, inclusive of intervals (T₂, T₃₁˜T₃₄) that are other than voice.

The above-described phenomenon is such that in a communication system in which a codec (encoder/decoder) is started up whenever a call is connected, for example, the entire signal that prevails during the connection of the call is identified as being voice activity if voice which includes background noise enters the encoder following a no-input state after start-up of the codec. As a consequence, the non-active voice compression effect can no longer be obtained.

Case 2:

If a voice signal on which background noise has been superimposed enters after a no-input state continues for a time during ordinary operation, the signal will be judged to be voice activity even if background noise only is present during the input of the signal. Specifically, this occurs in cases (a) and (b) below.

(a) In a state in which background noise does not enter prior to connection of a call, non-active voice is detected. However, if a call is connected and input of background noise starts, the signal is thenceforth judged to be voice activity even though it is solely background noise. The signal is judged to be non-active voice only after the call is disconnected and background noise ceases entering.

(b) If a mute button on a telephone continues being pressed for a time during a call, voice activity is identified after muting is cancelled and voice activity is identified thereafter even if background noise only is present.

This phenomenon also results in the non-active voice compression effect not being obtained.

The cause of the phenomenon in Case 1 is believed to be as follows: If, following resetting of the voice activity detector 1a, a non-active voice signal or low-level noise signal enters and then is followed by input of a voice signal on which noise having a signal level higher than that of the former signal is superimposed, updating of the background-noise characteristic parameters stops during input of the latter signal and these background-noise characteristic parameters no longer reflect the latest background noise. In other words, in Case 1, the value of the spectral difference SD is too large and Equation (11) will no longer in the decision of step 213. As a result, the background-noise characteristic parameters are the values of the 32 frames following the start of operation and are no longer updated. Hence, they no longer reflect the latest background noise and make it impossible to correctly identify voice activity.

The cause of the phenomenon in Case 2 is believed to be as follows: If a no-input state continues for a time during ordinary operation and then input of background noise starts and signal energy increases, updating of the background-noise characteristic parameters stops comparatively soon and the background-noise characteristic parameters no longer reflect the latest background noise. In other words, in Case 2, the cause is that the background-noise characteristic parameters are fixed at a very low level during the absence of an input signal and background noise that enters thereafter is regarded as voice activity in its entirety.

More specifically, in the decision processing of step 213 in the flowchart of FIG. 9, either or both of the following states arise: (1) the average value E_{F}⁻ of energy of background noise is very small and Equation (9) is not satisfied, and (2) the value of the spectral difference SD is too large and Equation (11) is not satisfied. As a consequence, the processing for updating the background-noise characteristic parameters at step 214 is not executed. This is believed to be the cause.

Accordingly, an object of the present invention is to so arrange it that the processing for updating the background-noise characteristic parameters will not stop, thereby allowing the background-noise characteristic parameters to reflect the latest background noise at all times.

Another object of the present invention is to so arrange it that even if a non-active voice signal or a noise signal of a low level is input following the resetting of a voice activity detector and this is followed by input of a voice signal on which noise having a signal level higher than that of the former signal is superimposed, the processing for updating the background-noise characteristic parameters will not stop, thereby allowing the background-noise characteristic parameters to reflect the latest background noise at all times.

Another object of the present invention is to so arrange it that even if a no-input state continues for a time during ordinary operation and then input of background noise starts and signal energy increases, the processing for updating the background-noise characteristic parameters will not stop, thereby allowing the background-noise characteristic parameters to reflect the latest background noise at all times.

### DISCLOSURE OF THE INVENTION

A first voice activity detector according to the present invention identifies whether a current frame is a non-active voice segment of background noise only or an active voice segment in which background noise has been superimposed on voice, based upon parameters representing background-noise characteristics and parameters representing voice characteristics of the current frame. The first voice activity detector (1) updates the parameters of the background-noise characteristics when predetermined update requirements have been satisfied, and (2) updates the parameters of the background-noise characteristics in each frame, irrespective of the update requirements, in an interval of time from start of a steady-state operation for detection of voice activity to identification of an active voice segment.

If the above arrangement is adopted, processing for updating the parameters representing the background-noise characteristics (the background-noise characteristic parameters) will not stop, so that these parameters can be reflect the latest background noise at all times. In particular, even if a non-active voice signal or a noise signal of a low level is input following the resetting of a voice activity detector and this is followed by input of a voice signal on which noise having a signal level higher than that of the former signal is superimposed, the processing for updating the background-noise characteristic parameters will not stop, thereby allowing the background-noise characteristic parameters to reflect the latest background noise at all times. As a result, the precision of voice activity/non-activity identification can be improved and it is possible to obtain the desired compression effect.

A second voice activity detector according to the present invention identifies whether a current frame is a non-active voice segment solely of background noise or an active voice segment in which background noise has been superimposed on voice, based upon parameters representing background-noise characteristics and parameters representing voice characteristics of the current frame. The second voice activity detector relaxes update requirements of the background-noise characteristic parameters based upon results of voice activity/non-activity identification and, when these update requirements are satisfied, updates the background-noise characteristic parameters. For example, the second voice activity detector relaxes the update requirements when (1) background-noise characteristic parameters have not been updated continuously for a fixed number of frames, (2) the difference between a maximum level and a minimum level in the fixed number of frames exceeds a predetermined threshold value, and (3) the minimum level in the fixed number of frames is less than a threshold value.

If this arrangement is adopted, processing for updating the parameters representing the background-noise characteristics (the background-noise characteristic parameters) will not stop, so that these parameters can be reflect the latest background noise at all times. In particular, even if a no-input state continues for a time during ordinary operation and then input of background noise starts and signal energy increases, the processing for updating the background-noise characteristic parameters will not stop, thereby allowing the background-noise characteristic parameters to reflect the latest background noise at all times. As a result, the precision of voice activity/non-activity identification can be improved and it is possible to obtain the desired compression effect.

### BRIEF DESCRIPTION OF THE DRAWINGS

FIG. 1 is a diagram showing the overall configuration of a communication system to which the present invention can be applied;

FIG. 2 is a diagram showing the structure of a voice signal encoding apparatus;

FIG. 3 is a diagram showing the structure of a voice signal decoding apparatus;

FIG. 4 is part 1 of a flowchart of first voice activity/non-activity identification processing;

FIG. 5 is part 2 of the flowchart of first voice activity/non-activity identification processing;

FIG. 6 is a flowchart of second voice activity/non-activity identification processing;

FIG. 7 shows an example of the configuration of a non-active voice compression communication scheme according to the prior art;

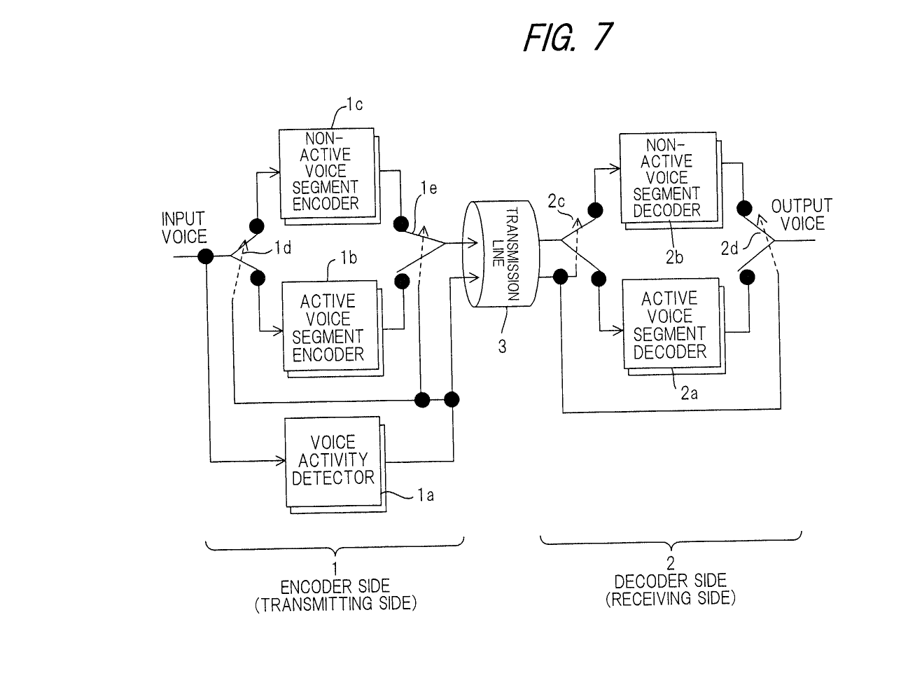

FIG. 8 is an abbreviated processing flowchart of voice activity detection processing;

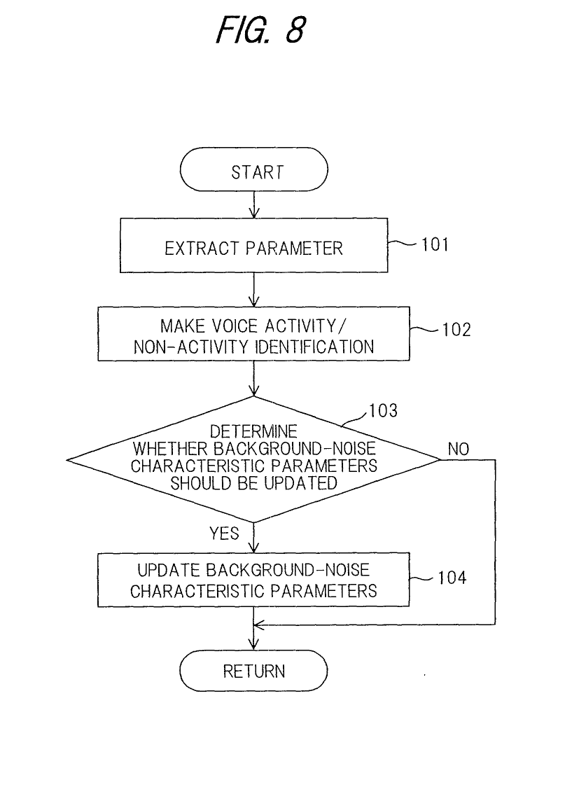

FIG. 9 is a processing flowchart illustrating processing performed by a voice activity detector in compliance with Recommendation ITU-T G.729 ANNEX B;

FIG. 10 is a processing flowchart of a step for determining whether or not to update background-noise characteristic parameters in the flow of ITU-T G.729 ANNEX B in FIG. 9; and

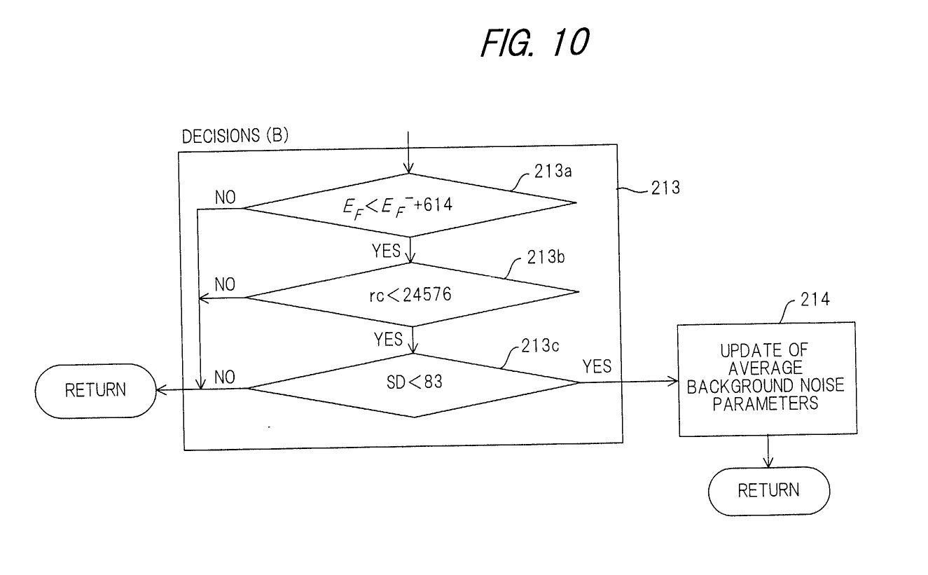

FIG. 11 is a diagram useful in describing adverse phenomena in which a non-active voice segment is regarded as an active voice segment.

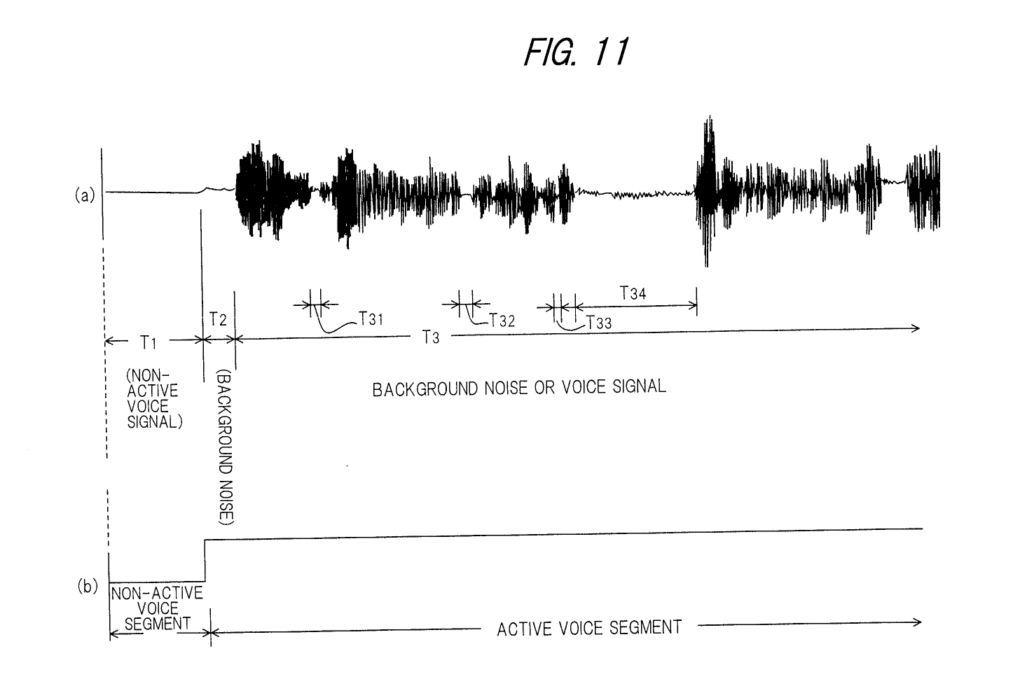

### BEST MODE FOR CARRYING OUT THE INVENTION

(A) Overall Configuration

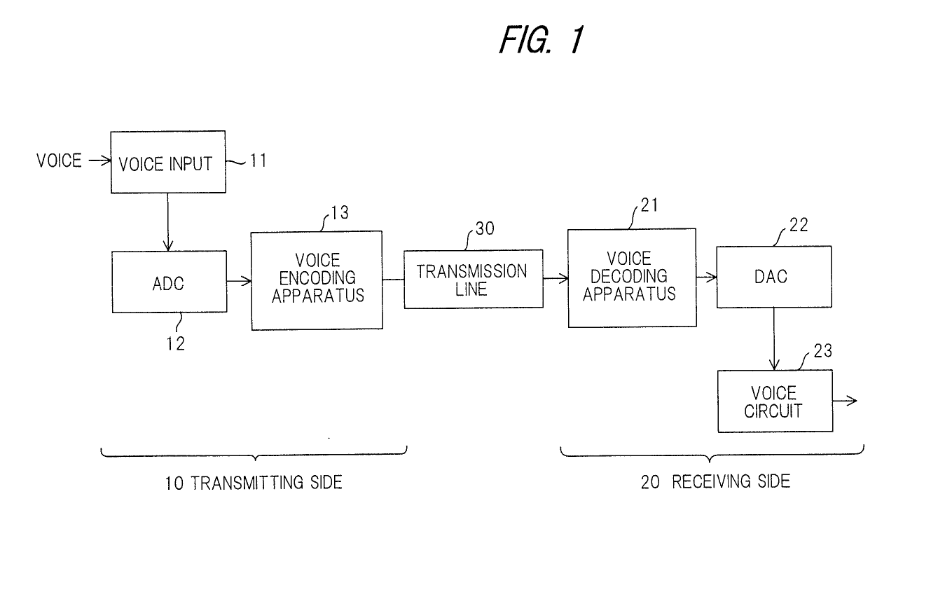

FIG. 1 is a diagram showing the overall configuration of a communication system to which the present invention can be applied. Numerals 10, 20 and 30 denotes a transmitting side, a receiving side and a transmission line, respectively. On the transmitting side are a microphone other voice input unit 11, an AD converter (ADC) 12 for sample an analog voice signal at, e.g., 8 kHz, and converting the signal to digital data, and a voice encoding apparatus 13 for encoding and then transmitting the voice data. On the receiving side are a voice decoding apparatus 21 for decoding the original digital voice data from the encoded data, a DA converter (DAC) 22 for converting PCM voice data to an analog voice signal, and a voice circuit 23 having an amplifier and speaker, etc.

(B) Voice Encoding Apparatus

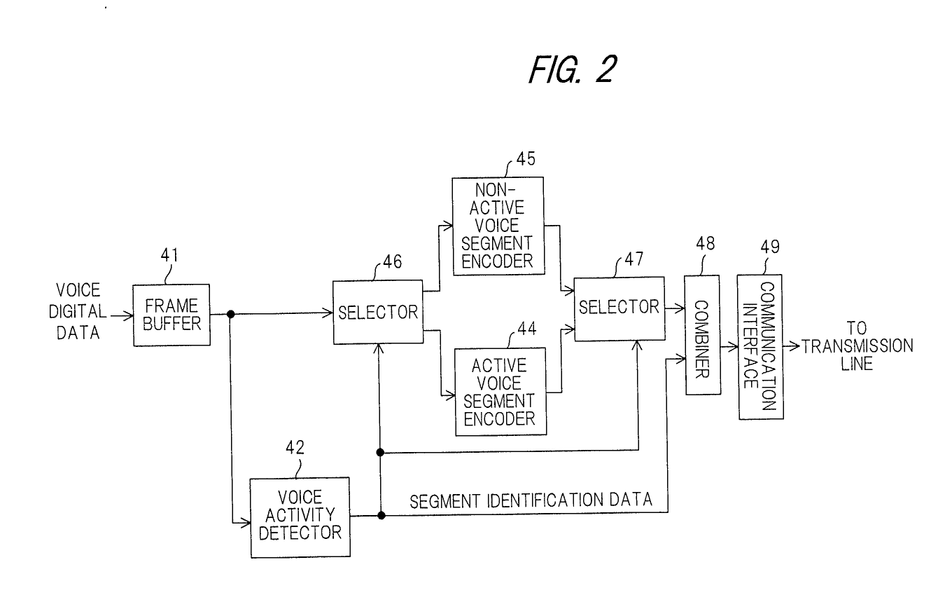

FIG. 2 is a diagram showing the structure of the voice encoding apparatus 13. Numeral 41 denotes a frame buffer for storing one frame of voice data. Since the voice data is sampled at 8 kHz, i.e., every 125 μs, one frame is composed of 80 samples of data. Numeral 42 denotes a voice activity detector which, using the 80 samples of data, controls other components upon identifying, on a per-frame basis, whether the frame is an active voice segment or a non-active voice segment, and outputs segment identification data indicative of an active voice segment or non-active voice segment. Numeral 44 denotes an active voice segment encoder for encoding voice data of active voice segments, and numeral 45 designates a non-active voice segment encoder which, in non-active voice segments, encodes and transmits information only when it is necessary to transmit information in order to generate background noise, and (2) halts the transmission of information when the transmission of information for generating background noise is unnecessary.

Numeral 46 denotes a first selector for inputting the voice data to the active voice segment encoder 44 if the voice data is an active voice segment, and for inputting the voice data to the non-active voice segment encoder 45 if the voice data is a non-active voice segment. Numeral 47 denotes a second selector for outputting compressed code data, which enters from the non-active voice segment encoder 44, if voice data is a non-active voice segment, and for outputting compressed code data, which enters from the non-active voice segment encoder 45, if voice data is a non-active voice segment. Numeral 48 denotes a combiner for creating transmit data by combining the compressed code data from the second selector 47 and the segment identification data. Numeral 49 denotes a communication interface for sending transmit data to a network in accordance with the communication scheme of the network. The voice activity detector 42, active voice segment encoder 44 and non-active voice segment encoder 45 are constituted by a DSP (digital signal processor).

The voice activity detector 42 identifies, on a per-frame basis, whether the frame is an active voice segment or a non-active voice segment in accordance with an algorithm, described later, and the active voice segment encoder 44 encodes, in active voice segments, the voice data of these active voice segments using a prescribed encoding scheme, e.g., ITU-T G.729 or ITU-T G.729 ANNEX A, as the 8 k CS-ACELP scheme. The non-active voice segment encoder 45 measures a change in a non-active voice signal, i.e., a noise signal, in non-active voice frames (non-active voice segments), thereby deciding whether information necessary to generate background noise should be transmitted or not. An absolute value and adaptive threshold value of frame energy and amount of spectral distortion, etc., are used in deciding whether of not to transmit the information. When transmission is required, information is transmitted that is necessary to generate, on the receiving side, a signal that is aurally equivalent to the original non-active voice signal (background-noise signal). This information contains information indicative of energy level and spectral envelope. If transmission is unnecessary, this information is not transmitted.

The communication interface 49 sends the compressed code data and segment identification data to the network in accordance with a prescribed transmission scheme.

(C) Voice decoding apparatus

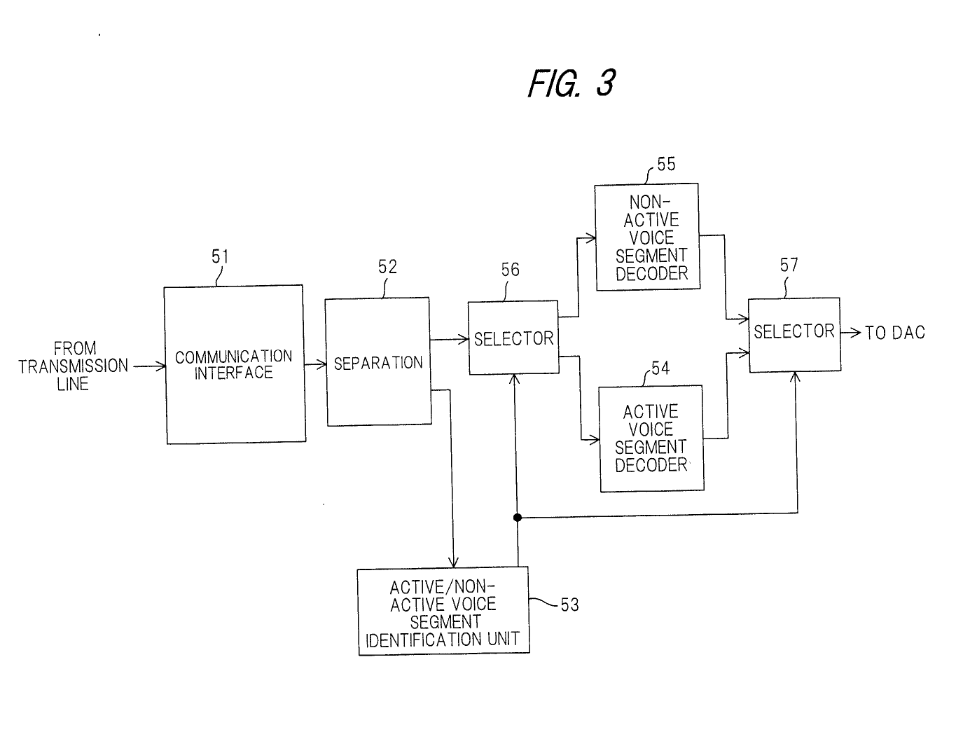

FIG. 3 is a diagram showing the structure of the voice decoding apparatus. Numeral 51 denotes a communication interface for receiving transmit data from a network in accordance with the communication scheme of the network. Numeral 52 denotes a separator for separating and outputting code data and segment identification data from the transmit data. Numeral 53 denotes an active/non-active voice segment identification unit for identifying whether the current frame is an active voice segment or non-active voice segment based upon the segment identification data. Numeral 54 denotes an active voice segment decoder which, in active voice segments, decodes the input code data into the original PCM voice data by a prescribed decoding scheme. Numeral 55 denotes a non-active voice segment decoder for creating and outputting background noise in non-active voice segments based upon the energy and spectral-envelope information of the non-active voice frame received from the encoding apparatus last. Numeral 56 denotes a first selector for inputting the code data to the active voice segment decoder 54 if the segment is an active voice segment, and for inputting the code data to the non-active voice segment decoder 55 if the segment is a non-active voice segment. Numeral 57 denotes a second selector for outputting PCM voice data that enters from the active voice segment decoder 54 if the segment is an active voice segment, and for outputting background-noise data that enters from the non-active voice segment decoder 55 if the segment is a non-active voice segment.

(D) Voice Activity/Voice Non-Activity Identification Processing

The voice activity detector 42 avoids the problems of the prior art by improving upon the method of updating the background-noise characteristic parameters in the processing for identifying voice activity/voice non-activity.

In first voice activity/voice non-activity identification processing according to the present invention, the adverse phenomena of Case 1 of the prior art are avoided by updating the background-noise characteristic parameters at all times over the entire interval from the start of steady operation to the identification of voice activity.

In second voice activity/voice non-activity identification processing according to the present invention, the adverse phenomena of Case 2 of the prior art are avoided by relaxing update requirements for updating the background-noise characteristic parameters based upon results of voice activity/voice non-activity identification and, when these update requirements are satisfied, updating the background-noise characteristic parameters.

(a) First Voice Activity/Voice Non-Activity Identification Processing

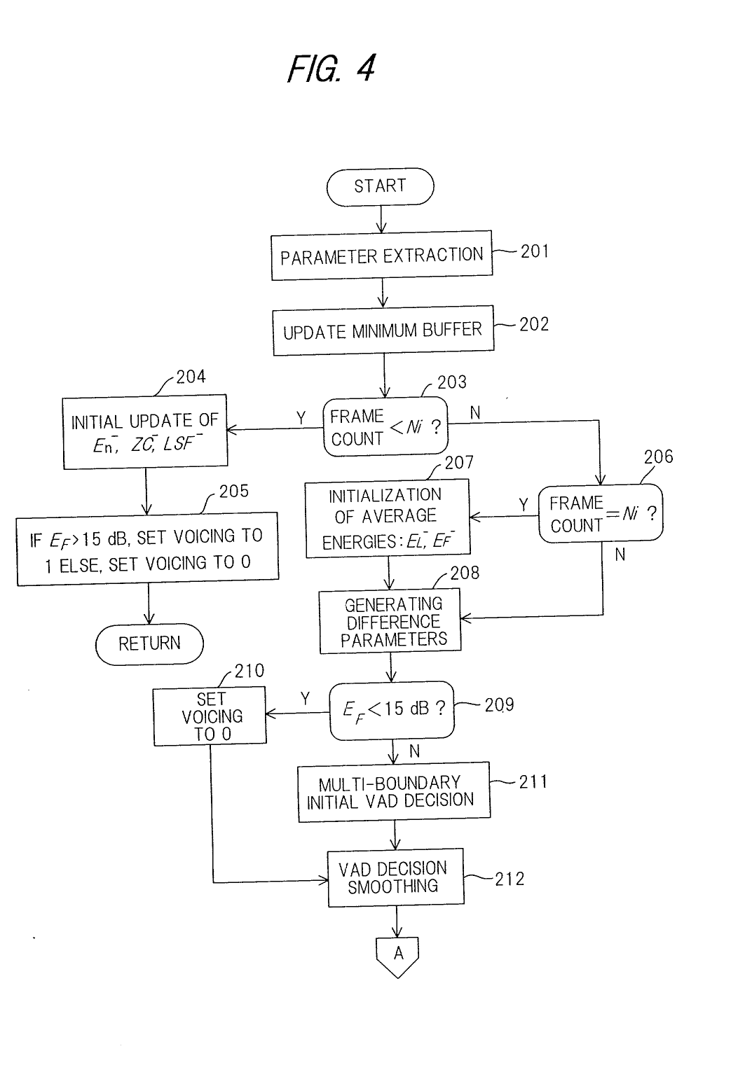

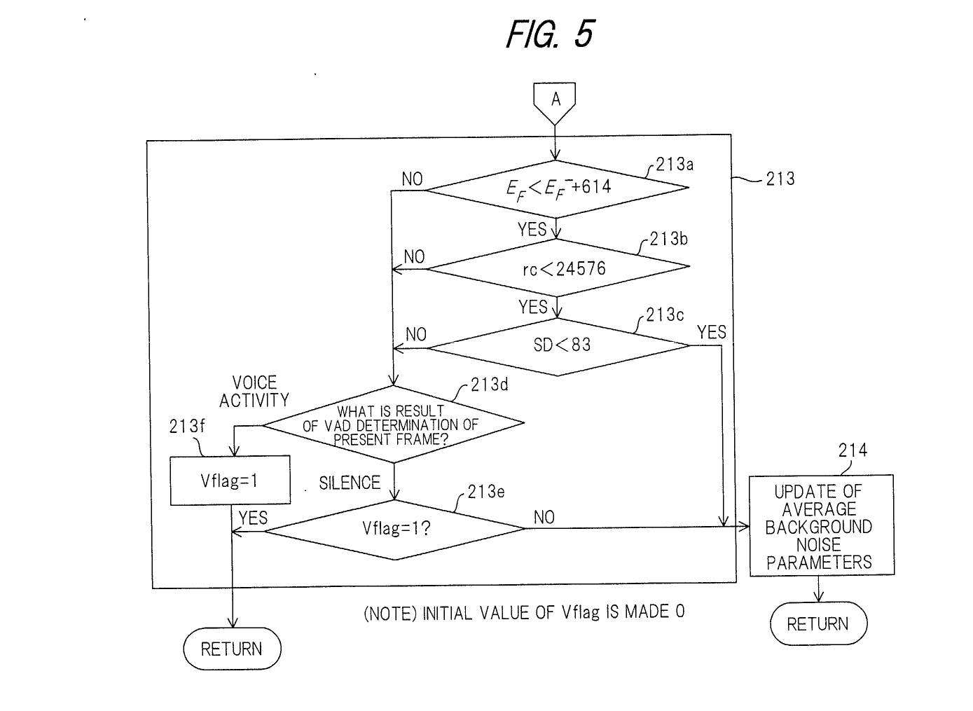

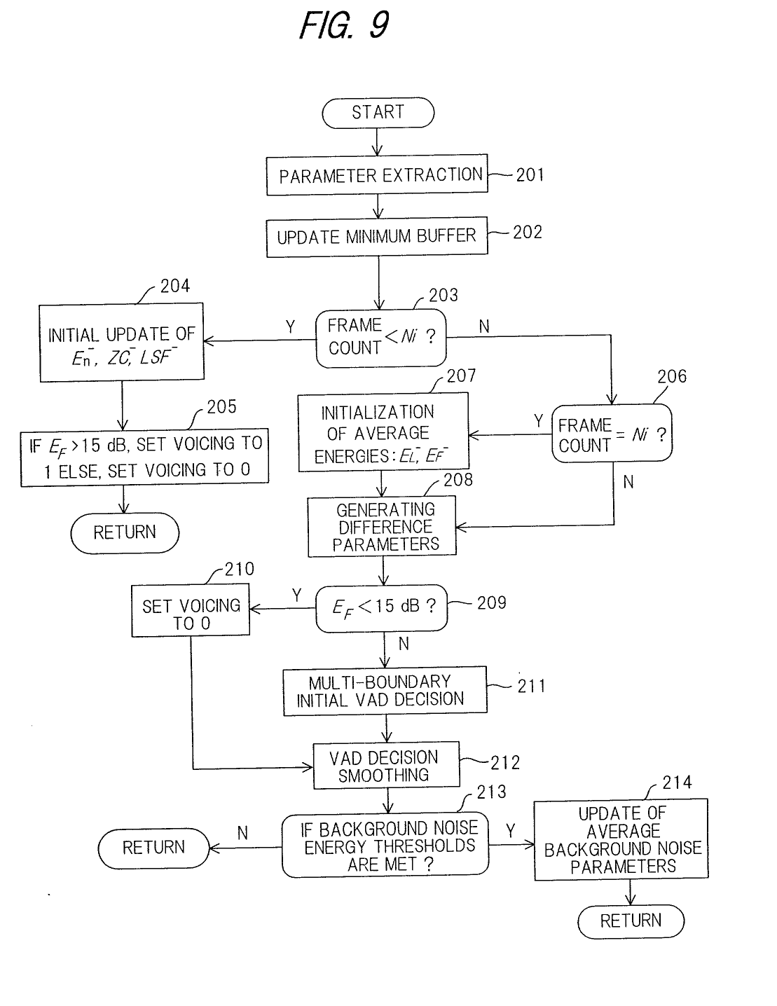

FIGS. 4 and 5 are flowcharts of first voice activity/voice non-activity identification processing. Steps identical with the conventional processing steps in FIG. 9 are designated by like step numbers. This flowchart differs in the voice activity identification processing of step 213 for updating the background-noise characteristic parameters.

According to the first voice activity/voice non-activity identification processing, the voice activity detector 42 performs updating of background-noise characteristic parameters over an entire interval (entire frame) from start of steady operation following resetting of the voice activity detector to identification of a active voice segment, whereby the background-noise characteristic parameters are allowed to reflect the latest background noise at all times. More specifically, the voice activity detector 42 updates the background-noise characteristic parameters, irrespective of the update requirements of Equations (9) to (11), over an entire non-active voice interval (entire frame) until a first active voice segment is detected after generation of 33 frames from being reset.

In other words, in the processing of step 213 for determining whether or not to perform updating in the flow of voice activity/voice non-activity identification processing, it is determined whether all of the requirements for updating the background-noise characteristic parameters indicated by Equations (9) to (11) are satisfied (steps 213a to 213c).

If all of the requirements are satisfied, the background-noise characteristic parameters E_{F}⁻, E_{L}⁻, LSF⁻ and ZC⁻ are updated (step 214). However, if any of the requirements of these equations (9) to (11) is not satisfied, it is determined whether the current frame is a non-active voice segment by referring to the results of processing performed at steps 210, 211 (step 213d). If the current frame is a non-active voice segment, then it is determined whether Vflag is 1 (step 213e). The initial value of Vflag is 0. If an active voice segment is detected after the start of voice activity detection, then the flag becomes 1 from this point onward. When it is found at step 213e that Vflag=0 holds, i.e., when an active voice segment has not been detected even once following the start of voice activity detection processing, then the background-noise characteristic parameters E_{F}⁻, E_{L}⁻, LSF⁻ and ZC⁻ are updated even if any of the requirements of these Equations (9) to (11) is not satisfied (step 214). As a result, the background-noise characteristic parameters reflect the latest background noise at all times.

On the other hand, if it is found at step 213d that the current frame is an active voice segment, the Vflag is made 1 (step 213f), the background-noise characteristic parameters are not updated and processing from step 201 onward is executed for the next frame. Further, if it is found at step 213e that Vflag=1 holds, then the background-noise characteristic parameters are not updated and processing from step 201 onward is repeated for the next frame. In other words, if an active voice segment is detected, as a result of which Vflag becomes 1, even once following the start of voice activity detection processing, then updating of the background-noise characteristic parameters is carried out subsequently so long as the update requirements of Equations (9) to (11) have been satisfied.

If the above arrangement is adopted, processing for updating the background-noise characteristic parameters will not stop and therefore these parameters will be able to reflect the latest background noise at all times. In particular, even if a non-active voice signal or a noise signal of a low level is input following the resetting of the voice activity detector 42 and this is followed by input of a voice signal on which noise having a signal level higher than that of the former signal is superimposed, the background-noise characteristic parameters can be updated until just before the above-mentioned voice signal enters. This means that the background-noise characteristic parameters can reflect the latest background noise at all times. As a result, the precision of voice activity/voice non-activity identification can be improved and it is possible to obtain the desired compression effect.

(b) Second Voice Activity/Voice Non-Activity Identification Processing

According to second voice activity/voice non-activity identification of the present invention, requirements for updating the background-noise characteristic parameters are relaxed based upon the results of voice activity/voice non-activity identification. That is, the set values (update target threshold values) EFTH, RCTH, SDTH are enlarged to make it easier to satisfy the requirement equations. If background-noise characteristic parameters are updated even once, the update target threshold values are set to the initial values used in ITU-T G.729 ANNEX B, after which the update requirements are relaxed in similar fashion based upon the results of voice activity/voice non-activity identification.

In order to relax the update requirements, it is necessary that all of the following requirements (1) to (3) hold:

(1) the background-noise characteristic parameters have not been updated continuously for a fixed number of frames (=th1);

(2) the difference between a maximum level EMAX and a minimum level EMIN of energy E_{F} in a fixed number of frames is greater than a predetermined threshold value (=thA); and

(3) the minimum level EMIN in the fixed number of frames is less than a threshold value (=thB).

If all of the above hold, then each update target threshold value is updated in accordance with the following equation:

(update target threshold value)=(update target threshold value)×α

(α>1.0) (16)

It should be noted that a fixed upper limit is set for the maximum value of the update target threshold value.

Thus, with the voice activity/voice non-activity identification processing of the present invention, the update requirements are relaxed when background-noise characteristic parameters have not been updated continuously for a fixed number of frames [(1)] and, moreover, the current frame apparently is a non-active voice segment [(2,), (3)]. Whether or not the current frame apparently is a non-active voice segment is determined based upon (2), (3). The reason for this is that if the signal is indicative of background noise, the difference between the maximum level EMAX and minimum level EMIN will be greater than the fixed value and, moreover, the minimum level EMIN will be low.

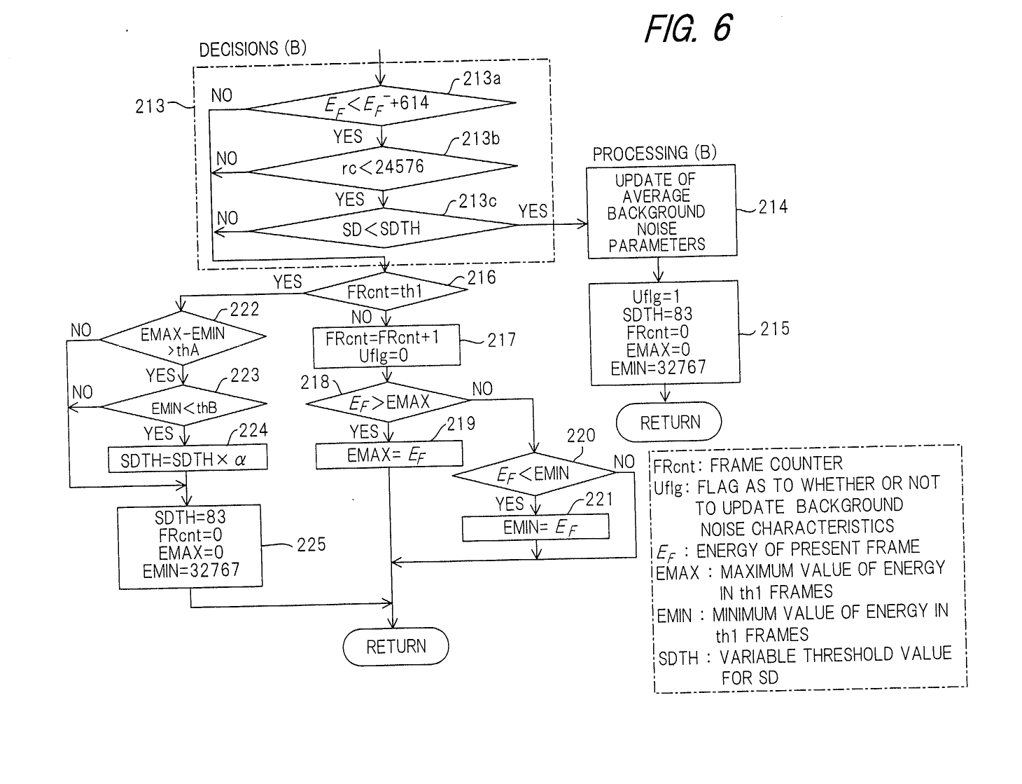

FIG. 6 is a flowchart of second voice activity/voice non-activity identification processing according to the present invention. The processing of steps 201 to 212 is identical with the conventional processing in FIG. 9 and therefore these steps are not illustrated. Further, the processing flowchart of FIG. 6 illustrates a case where only the update target threshold value SDTH of requirement equation (11) is updated.

In the processing of step 213 for determining whether or not to perform updating, it is determined whether all of the requirements for updating the background-noise characteristic parameters indicated by Equations (9) to (11) are satisfied (steps 213a to 213c). If all of the requirements are satisfied, the background-noise characteristic parameters E_{F}⁻, E_{L}⁻, LSF⁻ and ZC⁻ are updated (step 214) in a manner similar to that of the prior art. A flag Uflg as to whether or not background-noise characteristic should be updated is made 1, a frame counter FR_{CNT} is made 0, the update target threshold value SDTH is made 83, the maximum energy EMAX is made 0 and the minimum energy EMIN is made 32767 (step 215). Control then returns to the beginning and processing from step 201 onward is repeated for the next frame.

If it is found at step 213 that any of the requirements (9) to (11) is not satisfied, it is determined whether frame count FR_{CNT} is equal to the fixed frame count th1. That is, it is determined whether the background-noise characteristic parameters have not been updated continuously for the fixed number of frames (=th1) (step 216).

If FR_{CNT}<th1 holds, frame count FR_{CNT} is incremented (FR_{CNT}+1→FR_{CNT}) and the flag Uflg is made 0 (step 217). Next, it is determined whether the full-band energy E_{F} of the frame is greater than the maximum energy EMAX (step 218). If E_{F}>EMAX holds, E_{F} is adopted as the maximum energy EMAX (step 219). If E_{F}≧EMAX holds, it is determined whether the energy E_{F} is less than the minimum energy EMIN (step 220). If E_{F}<EMIN holds, then E_{F} is adopted as the minimum energy EMIN (step 221). After this updating of minimum and maximum energy is executed, control returns to the beginning and processing from step 201 onward is repeated for the next frame. If EMIN≦E_{F}≦EMAX, control returns to the beginning and processing from step 201 onward is repeated without updating the minimum and maximum energy.

If FR_{CNT}=th1 is found to hold at step 216, meaning that the background-noise characteristic parameters have not been updated continuously for the fixed number of frames (=th1), then it is determined whether the difference (EMAX-EMIN) between maximum energy and minimum energy is greater than the set value thA (step 222). If the difference is greater (EMAX−EMIN>thA), it is determined whether the minimum energy is less than the set value thB (step 223). If the minimum energy is less (EMIN<thB), then the update target threshold value SDTH of Equation (11) is increased (step 224) in accordance with the following equation:

SDTH=SDTH×α, α=1.25

Thereafter, or if either step 222 or 223 is “NO”, the following initialization is performed: SDTH=83, FR_{CNT}=0, EMAX=0, EMIN=32767 (step 225), control returns to the beginning and processing from step 201 onward is repeated for the next frame.

If the update target threshold value SDTH is increased at step 224, this makes it easier to satisfy the requirements for updating the background-noise characteristic parameters. If the requirements are satisfied, updating is performed at step 214. However, if the update requirements are not satisfied and “YES” decisions are rendered at steps 216, 222˜223, then the update target threshold value SDTH is increased further. As a result, the requirements for updating the background-noise characteristic parameters become easier and easier to satisfy. By thenceforth performing updating in the same fashion, the requirements for updating the background-noise characteristic parameters will eventually be satisfied and the background-noise characteristic parameters will be updated at step 214.

The processing flowchart of FIG. 6 illustrates a case where only the update target threshold value SDTH of requirement equation (11) is updated. The set value EFTH of Equation (9) can be updated separately or together with SDTH in the same manner.

If the above arrangement is adopted, processing for updating the background-noise characteristic parameters will not stop and therefore these parameters can be reflect the latest background noise at all times. In particular, even if a non-active voice signal or a noise signal of a low level is input following the resetting of a voice activity detector and this is followed by input of a voice signal on which noise having a signal level higher than that of the former signal is superimposed, the processing for updating the background-noise characteristic parameters will not stop, thereby allowing the background-noise characteristic parameters to reflect the latest background noise at all times. In particular, even if a no-input state continues for a time during ordinary operation and then input of background noise starts and signal energy increases, the processing for updating the background-noise characteristic parameters will not stop, thereby allowing the background-noise characteristic parameters to reflect the latest background noise at all times. As a result, the precision of voice activity/voice non-activity identification can be improved and it is possible to obtain the desired compression effect.

Thus, in accordance with the present invention, it is so arranged that a voice activity detector updates background-noise characteristic parameters in each frame, based upon background-noise characteristic parameters thus far and voice characteristic parameters of the frame, in an interval from start of steady operation to identification of an active voice segment. As a result, processing for updating the background-noise characteristic parameters will not stop and therefore the latest background noise can be reflected by these parameters at all times. In particular, even if a non-active voice signal or a noise signal of a low level is input following the resetting of the voice activity detector and this is followed by input of a voice signal on which noise having a signal level higher than that of the former signal is superimposed, the processing for updating the background-noise characteristic parameters will not stop, thereby allowing the background-noise characteristic parameters to reflect the latest background noise at all times. As a result, the precision of voice activity/voice non-activity identification can be improved and it is possible to obtain the desired compression effect.

Further, in accordance with the present invention, the arrangement is such that requirements for updating the background-noise characteristic parameters are relaxed based upon the results of voice activity/voice non-activity identification and, when these requirements have been satisfied, the background-noise characteristic parameters are updated based upon background-noise characteristic parameters thus far and the voice characteristic parameters of the frame of interest. As a result, processing for updating the background-noise characteristic parameters will not stop and therefore the latest background noise can be reflected by these parameters at all times. In particular, even if a no-input state continues for a time during ordinary operation and then input of background noise starts and signal energy increases, the processing for updating the background-noise characteristic parameters will not stop, thereby allowing the background-noise characteristic parameters to reflect the latest background noise at all times. As a result, the precision of voice activity/voice non-activity identification can be improved and it is possible to obtain the desired compression effect.

Further, in accordance with the present invention, requirements for updating the background-noise characteristic parameters are relaxed when (1) background-noise characteristic parameters have not been updated continuously for a fixed number of frames, (2) the difference between a maximum level and a minimum level in a fixed number of frames exceeds a predetermined threshold value, and (3) the minimum level in the fixed number of frames is less than a predetermined threshold value. As a result, the update requirements are relaxed successively when the current frame appears to be a non-active voice segment. This makes it possible to update the background-noise characteristic parameters by correctly detecting non-active voice segments.

What is claimed is:

1. A method of detecting voice activity and voice non-activity in a voice activity detector for identifying, based upon parameters representing background noise characteristics and parameters representing voice characteristics of a current frame, whether the current frame is a non-active voice segment of background noise only or an active voice segment in which background noise has been superimposed on voice, and updating the background noise characteristic parameters when predetermined update requirements have been satisfied, characterized by:
updating the background-noise characteristic parameters in each frame, irrespective of said update requirements, in an interval of time from resetting of the voice activity detector to identification of an active voice segment.

2. A method of detecting voice activity and voice non-activity in a voice activity detector for identifying, based upon parameters representing background noise characteristics and parameters representing voice characteristics of a current frame, whether the current frame is a non-active voice segment of background noise only or an active voice segment in which background noise has been superimposed on voice, and updating the background-noise characteristic parameters when predetermined update requirements have been satisfied, characterized by:
relaxing said update requirements based upon results of identification by the voice activity detector; and
updating said background-noise characteristic parameters when said update requirements have been satisfied.

3. A method of detecting voice activity and voice non-activity according to claim 2, characterized in that said update requirements are relaxed when (1) background-noise characteristic parameters have not been updated continuously for a fixed number of frames, (2) the difference between a maximum level and a minimum level in the fixed number of frames exceeds a predetermined threshold value, and (3) the minimum level in the fixed number of frames is less than a threshold value.

4. A voice activity detection apparatus for detecting whether a segment is a non-active voice segment of background noise only or an active voice segment in which background noise has been superimposed on voice, characterized by having:
means for identifying, based upon parameters representing background noise characteristics and parameters representing voice characteristics of a current frame, whether the current frame is a non-active voice segment or an active voice segment; and
means for updating the background-noise characteristic parameters when predetermined update requirements have been satisfied;
wherein said updating means updates the background-noise characteristic parameters in each frame, irrespective of said update requirements, in an interval of time from start of a steady operation for detection of voice activity after reset to identification of an active voice segment.

5. A voice activity detection apparatus for detecting whether a segment is a non-active voice segment of background noise only or an active voice segment in which background noise has been superimposed on voice, characterized by having:
means for identifying, based upon parameters representing background noise characteristics and parameters representing voice characteristics of a current frame, whether the current frame is a non-active voice segment or an active voice segment;
means for updating the background-noise characteristic parameters when predetermined update requirements have been satisfied; and
requirement relaxation means for relaxing said update requirements based upon results of voice activity and voice non-activity identification;
wherein said updating means updates the background-noise characteristic parameters when said update requirements have been satisfied.

6. A voice activity detection apparatus according to claim 5, characterized in that said requirement relaxation means relaxes said update requirements when (1) background-noise characteristic parameters have not been updated continuously for a fixed number of frames, (2) the difference between a maximum level and a minimum level in the fixed number of frames exceeds a predetermined threshold value, and (3) the minimum level in the fixed number of frames is less than a threshold value.

7. A voice encoding apparatus having a voice activity detector for detecting whether a segment is a non-active voice segment of background noise only or an active voice segment in which background noise has been superimposed on voice, an active voice encoder for encoding input Voice in a voice activity interval in accordance with a predetermined encoding scheme and sending the encoded voice to a voice decoder, and a non-active voice encoder for encoding information, which is necessary to generate background noise, in a non-active voice segment and sending the encoded information to the voice decoder, characterized in that said voice activity detector has:
means for identifying, based upon parameters representing background noise characteristics and parameters representing voice characteristics of a current frame, whether the current frame is a non-active voice segment or an active voice segment;
means for sending identification information, which indicates a distinction between an active voice segment and a non-active voice segment, to the voice decoder; and
means for updating the background-noise characteristic parameters when update requirements have been satisfied;
wherein said updating means updates the background-noise characteristic parameters in each frame, irrespective of said update requirements, in an interval of time from start of a steady operation for detection of voice activity after reset to identification of an active voice segment.

8. A voice encoding apparatus having a voice activity detector for detecting whether a segment is a non-active voice segment of background noise only or a active voice segment in which background noise has been superimposed on voice, an active voice encoder for encoding input voice in a voice activity interval in accordance with a predetermined encoding scheme and sending the encoded voice to a voice decoder, and a non-active voice encoder for encoding information, which is necessary to generate background noise, in a non-active voice segment and sending the encoded information to the voice decoder, characterized in that said voice activity detector has:
means for identifying, based upon parameters representing background noise characteristics and parameters representing voice characteristics of a current frame, whether the current frame is a non-active voice segment or an active voice segment;
means for sending identification information as to whether a segment is an active voice segment or a non-active voice segment to the voice decoder; and
means for updating the background-noise characteristic parameters when predetermined update requirements have been satisfied; and
requirement relaxation means for relaxing said update requirements based upon results of voice activity and voice non-activity identification;
wherein said updating means updates the background-noise characteristic parameters when said update requirements have been satisfied.

9. A voice encoding apparatus according to claim 8, characterized in that said requirement relaxation means relaxes said update requirements when (1) background-noise characteristic parameters have not been updated continuously for a fixed number of frames, (2) the difference between a maximum level and a minimum level in the fixed number of frames exceeds a predetermined threshold value, and (3) the minimum level in the fixed number of frames is less than a threshold value.
